(19) United States
(12) Patent Application Publication
(10) Pub. No.: US 2018/0271306 A1
(43) Pub. Date: Sep. 27, 2018

(54) MULTIPURPOSE VASE

(71) Applicant: Teters Floral Products, Inc., Bolivar, MO (US)

(72) Inventor: Ntxhuav Kong, Nixa, MO (US)

(73) Assignee: Teters Floral Products, Inc., Bolivar, MO (US)

(21) Appl. No.: 15/465,038

(22) Filed: Mar. 21, 2017

(51) Int. Cl. A47G 7/06; A01G 9/02

(52) U.S. Cl. CPC A47G 7/06; A01G 9/02

(57) ABSTRACT

A multipurpose vase having a convertible base and elongated member for anchoring the vase is disclosed. The vase may have an interior void where the elongated member can be stored when it is not used to secure the vase to a surface. The base can be oriented differently depending on whether the elongated member is used to secure the vase to a surface or whether the vase rests on a horizontal surface without use of the elongated member.

### FIELD

The present invention relates generally to vases. More specifically, the invention relates to a multipurpose vase that can rest on a planar horizontal surface or be secured to the ground using an elongated member inserted in the ground.

### BACKGROUND

Vases come in many shapes and sizes and are commonly used to display floral arrangements or other types of plants. They can be found both indoors and outdoors. Most vases, especially the indoor type, are designed to rest on flat, even surfaces. Some outdoor vases rest on rough surfaces such as grass, mulch, or gravel. One such scenario is when a vase is placed next to a headstone at a cemetery. Because of the uneven grassy terrain in a cemetery, as well as potentially harsh weather conditions, cemetery vases are usually anchored into the ground using some type of spike to keep the vase from tipping over or blowing away.

It is rare to find a vase that can be used both indoors on flat surfaces and anchored to the ground outdoors. U.S. Pat. No. 2,733,549 to Moore describes such a vase, as does U.S. Pat. No. 8,091,277 to Hajianpour et al. Both Moore and Hajianpour disclose vases having detachable elongated members that can be used to anchor the devices to the ground. The elongated member can be removed when the vase is placed on a flat surface such as a table, or the member can remain attached to the vase when it needs to be anchored into the ground. A problem with the Moore and Hajianpour vases is that there is no means for storing the elongated member when it is not being used. When the elongated member is removed to allow the vase to rest on a flat surface, the member must be discarded or stored separate from the vase, which could result in the member being lost. If the Moore or Hajianpour vases are first used on a flat surface and the elongated member is lost or discarded, the vases cannot later be anchored in the ground, thus it would be difficult to use the vases multiple times for different applications.

There remains a need in the art for a vase that is convertible and multipurpose, and that can be used multiple times in a variety of settings. To accomplish this, the vase must not only have detachable ground anchor but the anchor must be able to be stored with the vase at all times to avoid losing the anchor. The ability to retain the ground anchor with the vase, even when the anchor is not used, is key for a vase to be used multiple times in a variety of settings.

### SUMMARY

The present invention is directed to a multipurpose vase with convertible base and elongated member for anchoring the vase. The vase may comprise a body having a sidewall extending upwardly from a bottom to a rim, with the sidewall defining an interior void. The bottom may include an aperture for receiving the elongated member. The elongated member may be removably securable to the bottom portion of the body and adapted to secure the vase to a surface such as the ground.

The elongated member may have a pointed end and a locking end with posts extending outwardly therefrom. The pointed end may be inserted into the ground to secure the vase thereto. The posts can lock or secure the member to the body via the posts engaging a collar attached to the center of the bottom of the body, with the collar surrounding or encircling the aperture. The elongated member may be oriented in at least two positions. In a first position, it may be stored at least partially within the interior void such that a first end of the member is completely in the void. This may be appropriate when the member is not used to secure the vase to a surface. In a second position, the member may be removably secured to the bottom such that the first end is completely out of the void. In either position, the member may be removably secured in the aperture in the bottom of the body.

When the elongated member is engaged with and secured to the body, at least a portion of the base may be located between at least a portion of the member and the body. The base may be positioned under the bottom of the vase and held adjacent to the bottom by the elongated member. The base can have a first planar surface on a first side and a second planar surface on a second side as well as a wall extending upwardly from the periphery of the first planar surface. The base may be oriented such that the first planar surface faces upwardly and the second planar surface faces downwardly when the elongated member is used to secure the vase to a surface. Conversely, the first planar surface may face downwardly and the second planar surface may face upwardly when the elongated member is not used to secure the vase to a surface, such as when the vase rests unsecured on a horizontal surface. When the elongated member is stored in the void of the body, the pointed end of the member is located above the locking end of the member and below the rim. The elongated member may be attached to the base (integrally or otherwise) or separate from it.

### BRIEF DESCRIPTION OF THE DRAWINGS

FIG. 1 is a perspective view of a multipurpose vase with convertible base and spike in accordance with a first exemplary embodiment of the present invention shown in a first configuration.

FIG. 2 is a perspective view of the multipurpose vase of FIG. 1 shown in a second configuration.

FIG. 3 is a cross sectional view of the multipurpose vase of FIG. 1.

FIG. 4 is a cross sectional view of the multipurpose vase of FIG. 2.

FIG. 5 is a plan view of the bottom interior of the multipurpose vase of FIG. 1 wherein the spike is in a downwardly extending position with respect to the base.

FIG. 6 is an exploded view of the multipurpose vase of FIG. 2.

FIG. 7 is a cut-away view of the spike locking mechanism of the multipurpose vase of FIG. 1.

FIG. 8 is an enlarged view of the spike locking mechanism in FIG. 7.

### DETAILED DESCRIPTION OF EXEMPLARY EMBODIMENTS

Various embodiments of the present invention are disclosed herein, it is to be understood that the disclosed embodiments are merely exemplary of the invention, which may be embodied in various forms. Thus, any specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof

Certain terminology used in the following description is for convenience in reference only and is not limiting. For example, the words “vertically,” “horizontally,” “vertical,” “horizontal” and “upwardly,” “downwardly,” “upper,” “lower” all refer to the depicted position of the element or embodiment to which the reference is made. The words “inwardly” and “outwardly” refer to directions toward and away from, respectively, the geometric center of the embodiment being designated and parts thereof. The terminology used herein may include the words specifically mentioned, derivatives thereof and words of a similar import. It is further understood that terminology such as the aforementioned directional phrases may be used to describe exemplary embodiments of the vase with convertible base and spike as shown in the figures herein. This is for convenience only as it is understood that the exemplary embodiments of the vase described may also be used in other orientations.

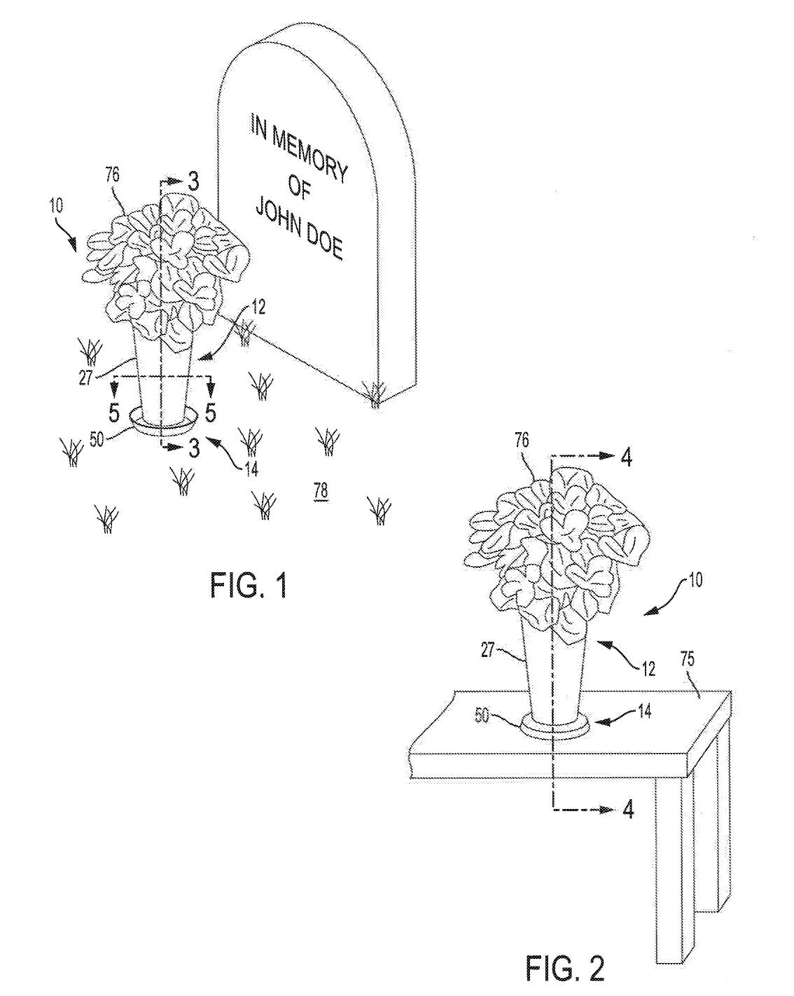

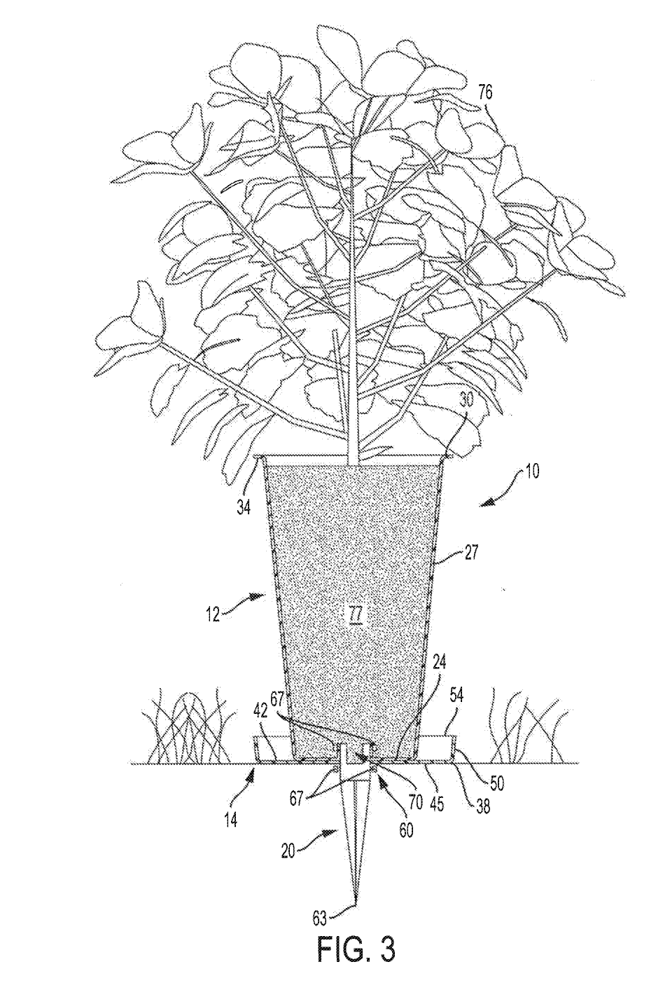

Referring to the drawings, a multipurpose vase with convertible base and spike in accordance with an exemplary embodiment of the present invention is generally indicated by reference numeral 10. Vase 10 includes a vase body 12, base 14 and a ground anchoring elongated member or spike 20. The vase 10 may be configured such that it may be anchored to the ground (FIG. 1) or such that it may rest on a flat horizontal surface such as a table (FIG. 2). When the vase 10 is anchored to the ground, the spike 20 extends downwardly from vase body 12 as shown in FIG. 3. When the vase 10 is configured to rest on a flat surface, the spike 20 is inverted and it is stored substantially within an internal void 21 formed in vase body 12. It should be further understood that the embodiments described herein are directed to a generally cylindrical vase, but the invention may come in other shapes such as cuboid, pyramidal, and frustoconical (including inverted variations of each), for example without limitation.

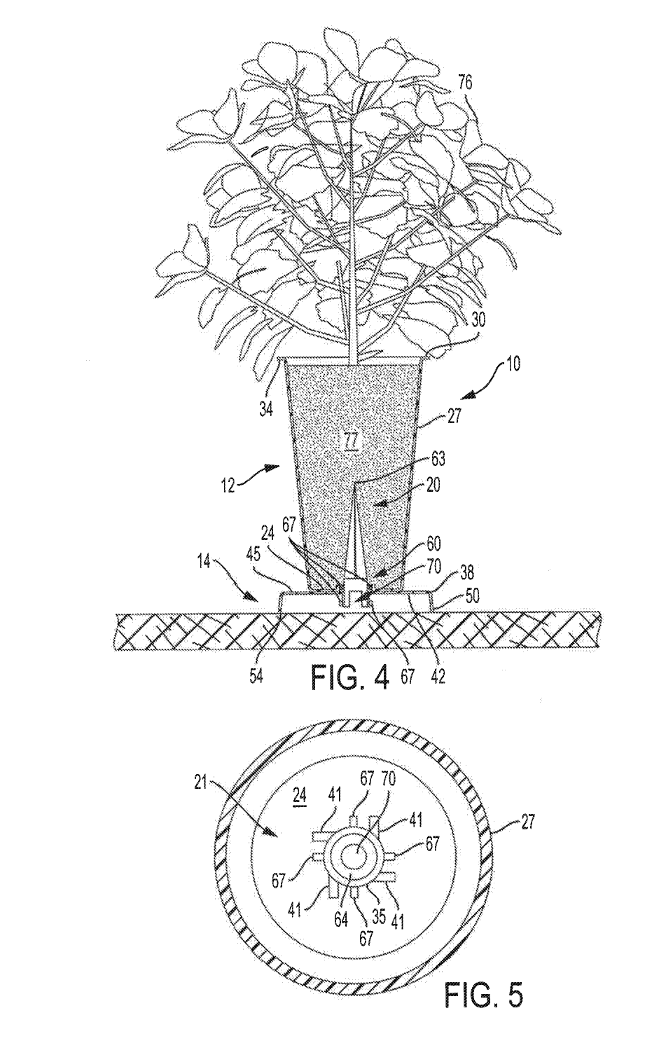

Looking at FIGS. 3 and 4, the vase body 12 comprises a circular bottom 24 and circumferential sidewall 27. Sidewall 27 is integrally formed with bottom 24 and extends upwardly therefrom to a rim 30. Sidewall 27 is generally cylindrical, however in the embodiment shown, the sidewall 27 tapers inwardly slightly toward bottom 24. Therefore, the circumference of the upper portion of sidewall 27 is slightly larger than that of the lower portion. Rim 30 includes an annular ledge 34 extending outwardly from sidewall 27. Sidewall 27 is formed around internal void 21, which extends from bottom 24 upward to rim 30.

Attached to circular bottom 24 proximate its center point is a collar 35. Collar 35 extends upwardly from bottom 24 approximately one half inch and encircles an aperture or opening 36. As described in more detail below, spike 20 may be inserted in opening 36 and received in collar 35 when the spike 20 is in a stored position. One or more slots 37 may be formed in collar 35 to receive locking members or locking posts 67 extending from spike 20 as described below. The slots 37 are equally spaced around collar 35 and the number of slots corresponds to the number locking posts on spike 20. A typical number of slots is four. Each slot 37 comprises a horizontal segment 39 and a vertical segment 40 configured in an inverted L-shape on collar 35. Vertical segment 40 has a first end at the base of collar 35 and extends upwardly to a second end located proximate the vertical midsection of the collar 35. Horizontal segment 39 extends horizontally from the second end of vertical segment 40 for approximately the same distance as the length of vertical segment 40. A portion of horizontal segment 39 includes an upwardly extending protuberance, which forms a catch 43 to keep locking posts seated in the horizontal segment 39. Adjacent to each slot 37 is another slot 41 formed in bottom 24 that extends outwardly from collar 35 at the first end of vertical segment 40.

Vase 10 includes a base 14 upon which the vase body 12 rests. As shown in FIG. 3, the base 14 has a circular support platform 38 comprising a first support surface 42 on one side of the platform and a second support surface 45 on the opposite side of the platform. Base 14 includes a circumferential wall 50 extending from the first support surface 42 of support platform 38 proximate the periphery of the platform. Wall 50 flares outwardly from support platform 38 slightly as the wall 50 extends away from the platform such that the rim 54 of wall 50 has a slightly larger diameter than support platform 38. The first support surface 42 faces upward and contacts the underside of bottom 24 when base 14 is used as a tray (FIG. 3), such as when vase 10 is configured to be anchored in the ground. When the base 14 is used as a pedestal (FIG. 4), the second support surface 45 faces upwardly and contacts the underside of bottom 24.

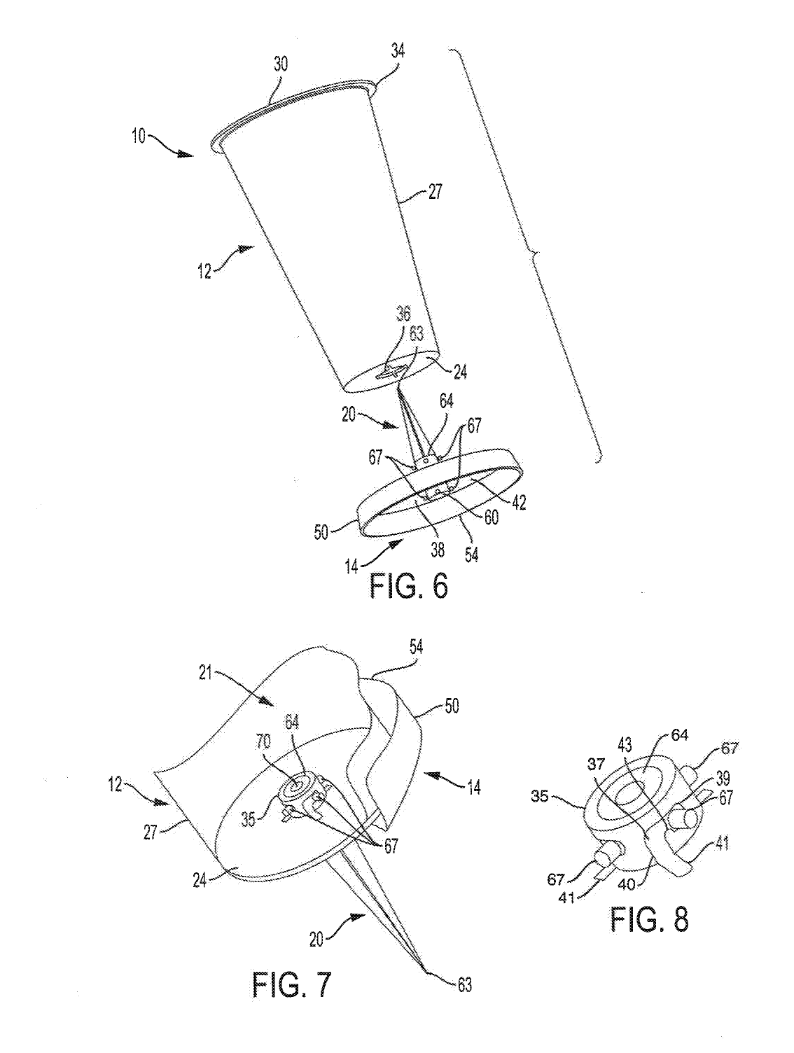

As best seen in FIGS. 3, 4, 6 and 7, vase 10 also includes a spike 20, which may be attached to (integrally or otherwise) or separate from base 14. One end of the spike 20, herein referred to as the locking end 60, can be locked or engaged with vase body 12 to keep the spike 20 fixed with respect to body 12. Opposite from the locking end 60 is the pointed end 63 of the spike 20, which is adapted for insertion into the ground. The locking end 60 comprises a cylindrical locking hub 64 with two spaced apart sets of locking posts 67 extending radially from the circumference of the cylindrical hub 64.

Each set of posts includes four locking posts 67 equally spaced around the hub 64 with each post 67 extending outwardly from the cylindrical hub 64. Each locking post 67 is a generally cylindrical member extending perpendicularly outward from hub 64. The two sets of locking posts 67 are spaced apart such that the first set of posts 67 is proximate the top, or distal end, of cylindrical hub 64, and the second set of posts is spaced downwardly from first set of posts in the direction of the pointed end 63 of the spike 20. The distance between the two sets of locking posts 67 will depend on the exact configuration of the collar 35 into which hub 64 is inserted; however a typical distance is approximately one half inch. The distance between the two sets of locking posts 67 depends on whether the spike 20 is integral to or separate from base 14. If the spike 20 is integral to base 14, the distance between the two sets of locking posts 67 may be approximately equal to twice the distance between a horizontal segment 39 on collar 35 to bottom 24 of vase body 12.

Base 14 is attached to spike 20 approximately halfway between the two sets of locking posts 67. If spike 20 is separate from base 14, the distance between the two sets of locking posts 67 is approximately the same as the distance between a horizontal segment 39 on collar 35 to bottom 24 of vase body 12. Cylindrical hub 64 may include central void 70 extending downwardly from the top of the hub proximate the longitudinal centerline of the cylinder. Void 70 may be necessitated by the manufacturing process and to help minimize the amount of material (and associated material cost) required for spike 20.

To use the vase 10, the user first determines whether the vase 10 will rest atop a flat horizontal surface 75 or whether it will be mounted in the ground 78. This will dictate the configurations or positions of base 14 and spike 20 If the vase will rest atop horizontal surface 75, the base 14 is oriented as shown in FIG. 4, with support surface 45 facing upwardly and the spike 20 extending upwardly from base 14 (Configuration 1). If the vase 10 is to be mounted in the ground 78, the base 14 is oriented as shown in FIG. 3, with support surface 42 facing upward and spike 20 extending downwardly from base 14 (Configuration 2). When the user has determined which of these configurations is appropriate, the base 14 and spike 20 are engaged with or locked to vase body 12.

To lock the base 14 and spike 20 to vase body 12, the locking hub 64 of spike 20 may be inserted into collar 35 and the spike rotated until the locking posts 67 on hub 63 are seated within corresponding slots 37 in collar 35. If spike 20 is separate from base 14, the base 14 first needs to be positioned along the spike 20 such that the base encircles the hub 64 at a location between the two sets of locking posts 67. After base 14 has been positioned on spike 20, or if it is attached (integrally or otherwise) to spike 20, the next step is to lock the base 14 and spike 20 to base body 12. For Configuration 1, the spike 20 is oriented such that it extends upwardly and the pointed end 63 of the spike is inserted into opening 36 of collar 35. The spike 20 is inserted into opening 36 until spike 20 is substantially within internal void 21 of vase body 12. As the spike is inserted into opening 36, the first set of locking posts should be aligned with slots 41 in bottom 24. The locking posts 67 are pushed through the slots 41 and into the vertical segments 40 of slots 37 in collar 35. After the locking posts 67 have moved through vertical segments 40 and reach the horizontal segments 39 of slots 37, spike 20 may be rotated to move the posts over catch 43 to the end of horizontal segment 39. When locking posts 67 are seated in horizontal segments 39, the base 14 and spike 20 are engaged with or locked to base body 12.

The locking process is the same for Configuration 2 except that the spike 20 is oriented such that it extends downwardly away from body 12 and the spike 20 is not stored within internal void 21. For Configuration 2, the locking end 60 of spike 20 is inserted into opening 36 of collar 35 rather than the pointed end 63, and the second set of locking posts 67 engage with horizontal segments 39 rather than the first set of locking posts.

Vase 10 can be used to hold a floral arrangement 76, which may be synthetic or organic, or other type of plant feature. Soil 77 may be placed in the vase 10 if organic flowers are used. It is foreseen that items other than plant features may also be placed in the vase.

It should be understood that while certain forms and embodiments have been illustrated and described herein, the present invention is not to be limited to the specific forms or arrangement of parts described and shown, and that the various features described may be combined in ways other than those specifically described without departing from the scope of the present invention. The terms “substantially,” “generally,” “approximately,” or any other qualifying term as used herein may be applied to modify any quantitative representation, which could permissibly vary without resulting in a change to the basic function to which it is related.

It is to be understood that while certain forms of this invention have been illustrated and described, it is not limited thereto, except in so far as such limitations are included in the following claims and allowable equivalents thereof.

Having thus described the invention, What is claimed as new and desired to be secured by Letters Patent is:

1. A vase comprising:
a body having a bottom and a sidewall extending upwardly therefrom presenting an interior void, said bottom having an aperture; and
an elongated member removably securable to said bottom, said elongated member adapted to secure the vase to a surface, said elongated member having a first position wherein said elongated member is removably secured in said aperture and a first end of said elongated member is in said interior void, and a second position wherein said elongated member is removably secured in said aperture and said first end of said elongated member is out of said interior void.

2. The vase of claim 1, wherein said surface is the ground outdoors.

3. The vase of claim 2, wherein said first end of said elongated member is adapted for insertion into said ground.

4. The vase of claim 3, wherein said elongated member further comprises a second end having posts extending outwardly from said second end.

5. The vase of claim 4, wherein said posts engage with a collar attached to said bottom to secure said elongated member to said bottom.

6. The vase of claim 5, wherein said collar encircles said aperture.

7. The vase of claim 6, wherein said first end of said elongated member is located above said second end when said elongated member is in said first position.

8. The vase of claim 7, wherein said collar is located proximate the center of said bottom.

9. A vase comprising:
a body having a sidewall extending upwardly from a bottom, said sidewall surrounding an interior void;
an elongated member removably securable to said body, said elongated member adapted to secure the vase to a surface, said elongated member being stored at least partially within said interior void when said elongated member is not used to secure the vase to a surface; and
a base positioned under said bottom, said base held adjacent to said bottom by said elongated member, said base having a first planar surface on a first side of said base and a second planar surface on a second side of said base, said base having a wall extending upwardly from said first planar surface proximate its periphery, wherein said first planar surface faces upward and said second planar surface faces downward when said elongated member is used to secure the vase to said surface, and wherein said first planar surface faces downward and said second planar surface faces upward when said elongated member is not used to secure the vase to said surface.

10. The vase of claim 9, wherein said surface is the ground outdoors.

11. The vase of claim 10, wherein said elongated member comprises a pointed first end for insertion into said ground.

12. The vase of claim 11, wherein said elongated member comprises a second end having posts extending outwardly from said second end.

13. The vase of claim 12, wherein said posts engage with a collar attached to said bottom to secure said elongated member to said body.

14. The vase of claim 13, wherein said collar is located proximate the center of said bottom.

15. The vase of claim 14, wherein said elongated member is integrally attached to said base.

16. A vase comprising:
a body having a sidewall extending upwardly from a bottom to a rim, said sidewall defining an interior void;
an elongated member removably securable to said body, said elongated member adapted to secure the vase to a surface, said elongated member being stored at least partially within said interior void when said elongated member is not used to secure the vase to said surface; and
a base positioned under said bottom, said base held adjacent to said bottom by said elongated member, said base having a first planar surface on a first side of said base and a second planar surface on a second side of said base, said base having a wall extending upwardly from said first planar surface proximate its periphery, wherein said first planar surface faces upward and said second planar surface faces downward when said elongated member is used to secure the vase to said surface, and wherein said first planar surface faces downward and said second planar surface faces upward when said elongated member is not used to secure the vase to said surface.

17. The vase of claim 16, wherein said elongated member comprises a pointed first end and a second end having posts extending outwardly from said second end.

18. The vase of claim 17, wherein said posts engage with a collar attached to said bottom proximate the center of said bottom to secure said elongated member to said body.

19. The vase of claim 18, wherein said first end of said elongated member is located above said second end when said elongated member is stored at least partially within said interior void when said elongated member is not used to secure the vase to said surface.

20. The vase of claim 19, wherein said first end of said elongated member is located below said rim when said elongated member is stored at least partially within said interior void when said elongated member is not used to secure the vase to said surface.
